(19) United States
(12) Patent Application Publication
(10) Pub. No.: US 2011/0214743 A1
(43) Pub. Date: Sep. 8, 2011

(54) METHOD OF USING NEW FLUSHING PORTS DURING CLEANING OF A PISTON ACCUMULATOR

(76) Inventor: Egil Eriksen, Foldroyhamn (NO)

(21) Appl. No.: 13/061,074

(22) PCT Filed: Aug. 28, 2009
(86) PCT No.: PCT/NO2009/000303

§ 371 Date: May 13, 2011

(30) Foreign Application Priority Data
Aug. 29, 2008 (NO) 20083748

(51) Int. Cl. B08B 9/00

(52) U.S. Cl. 137/1

(57) ABSTRACT

The invention relates to a method of using new flushing ports (IA7 IB) when cleaning a piston accumulator (7). Dirty hydraulic oil is returned out via the main port (2) and a return passage (9) until a cleanness grade has been reached. Clean hydraulic oil is forced into the piston accumulator (7) via the axial bores (3A, B) of the flushing ports (IA, B) and further in sloping bores (3C, D), bringing the hydraulic oil into the volume (8) in an upward, tangential direction below the piston (5), into a flushing circulation. By reducing the gas pressure on the gas side (4) of the piston (5) in relation to flushing pressure input from a valve (6), a volume (8) is created on the oil side between the piston (5) and the end bottom (3). The return passage (9) is closed and the piston (5) is brought into its upper position, so that an internal cylinder wall (10) is cleaned. Upon pressure build-up, the return passage (9) is opened, and the piston (5) returns to its end position on the oil side while the supply of clean hydraulic oil is maintained, and the operation is repeated until a cleanness grade has been achieved.

The invention relates to a method of using new flushing ports when cleaning a piston accumulator, as specified in the introduction to the accompanying claim 1.

The method of the application represents a more effective cleaning of piston accumulators in connection with the flushing of hydraulic systems, as specified in the introduction to the accompanying claim 1.

Today, cleaning is carried out by washing/flushing piston accumulators by repeatedly pumping hydraulic fluid into and letting hydraulic fluid out of the accumulator, until the hydraulic fluid comes out clean.

From the patent literature are cited as the background art:

WO 2006/079931 A1 disclosing flushing of accumulated particles, typically sand, from the bottom of a process container without a piston, the particles being brought against the accumulator wall in a rotating, vortex-like flow pattern.

DE 4337380 A1 disclosing a cleaning device for cleaning drain pipes, there being no similarities to the invention of the application in purpose and embodiment.

EP 0854296 B1 dealing with a particular accumulator, in which a sealing medium in the space between two piston parts of a double piston is compressed by a biasing spring. This medium functions together with the piston seals as a seal between the hydraulic side and the gas side. There is no description of flushing ports in the patent.

GB 846307 A1 disclosing a special accumulator with an integrated filter device at the hydraulic oil side. The object of the invention is to avoid having a separate high-pressure filter housing, the lower end of the accumulator being used as a filter housing. There is no description of flushing ports in the patent.

Running the piston cyclically in connection with cleaning of the piston accumulator has several drawbacks:
1. It is a time-consuming operation, getting the particle contents of the accumulator down to a desired cleanness grade by running the piston.
2. There is a problem getting remains of dirt accumulating at the bottom of the accumulator out by known methods.
3. Long-duration running of the piston gives wear, and wear from the piston also causes particles to mix into the hydraulic fluid.
4. There is a risk of galling between the piston and cylinder wall, and it has happened that accumulators have become ruined during flushing, because of this operation.

Thus, there is a need for a more effective method of cleaning piston accumulators, reducing the wear from the piston at the same time.

The present application relates to a method of using new flushing ports when cleaning a piston accumulator, and the method is characterized by the characteristics set forth in the claims.

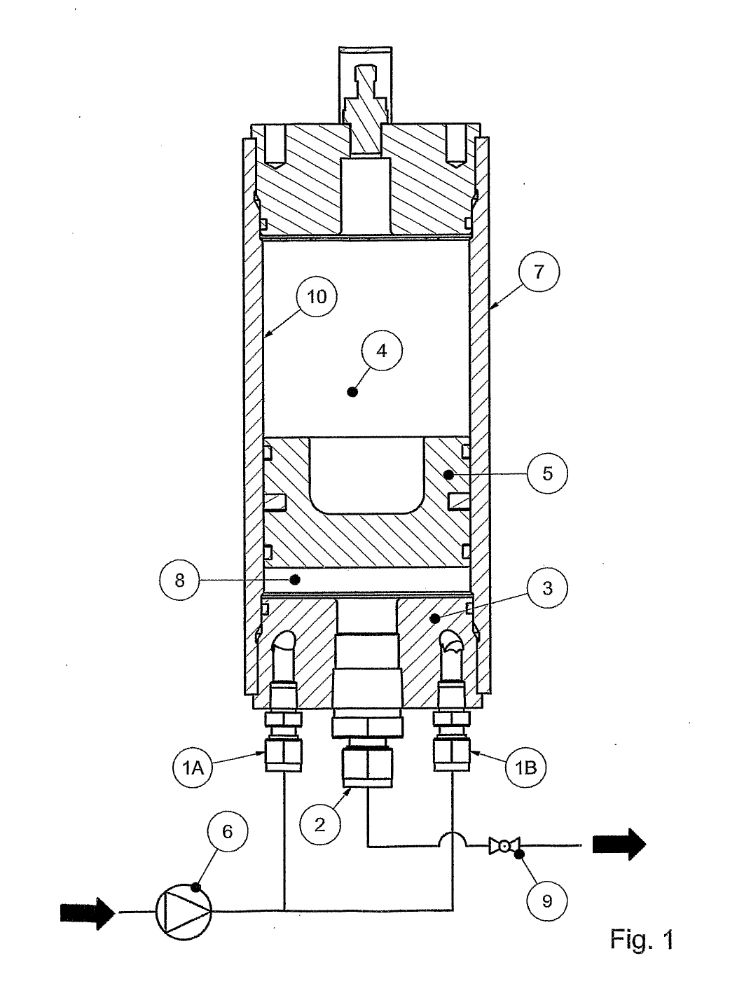

FIG. 1 shows a sectional side view of a piston accumulator, having:
1A and 1B new flushing ports positioned radially out from main inlet 2 on the oil side,
2 main inlet
3 end bottom
4 gas side of piston 5
5 piston
6 valve for flushing pressure input
7 piston accumulator
8 volume below piston 5
9 return passage
10 internal cylinder wall

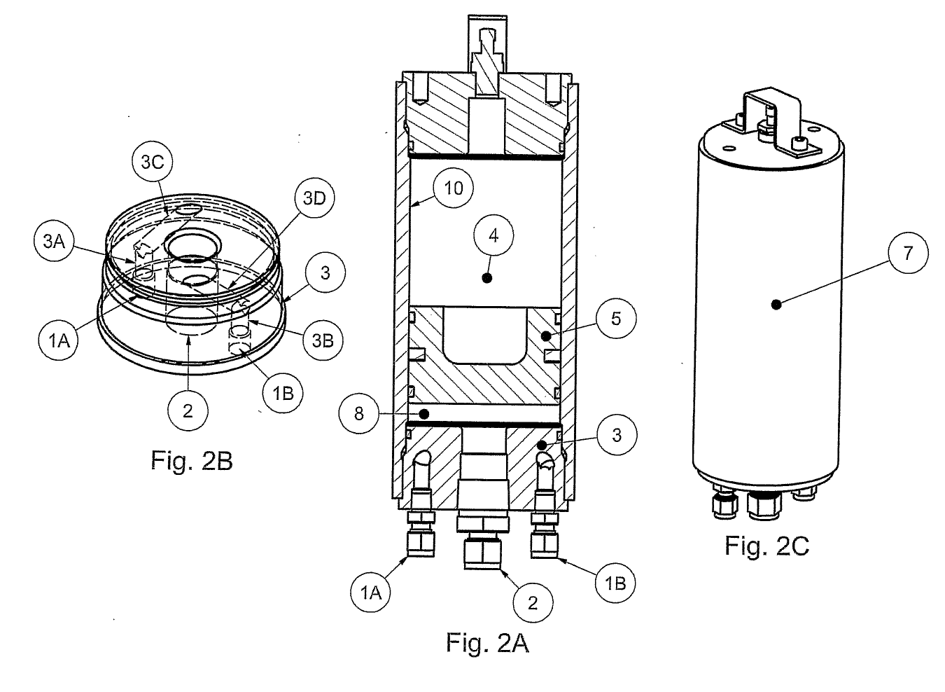

FIGS. 2A-C are arrangement drawings of the piston accumulator 7.

FIG. 2A shows a side section of the arrangement drawing.

FIG. 2B shows in 3D how the flushing fluid is brought into circulation from the two new flushing ports 1A and 1B in that bores 3A, 3B directed upwards are provided axially in the end bottom 3 of the accumulator, meeting sloping bores 3C, 3D directed downwards in the material from the top side of the end bottom. The straight and sloping bores 3A, 3B, 3C and 3D thus form flushing channels extending in pairs through the end bottom 3. When the clean hydraulic fluid enters at the oil side of the accumulator via the flushing ports 1A, 1B and changes its direction via the sloping bores 3B, 3C, so that it meets the internal cylinder wall 10 and the bottom side of the piston 5 in a partially upward and tangential direction, the volume 8 below the piston is brought to rotate in a vortex having its outlet through the main port 2. This contributes to efficiently flushing particles out from the bottom of the accumulator.

The gas pressure on the gas side 4 of the piston 5 is reduced in relation to the flushing pressure input from the valve 6 to the accumulator 7. The gas is compressed somewhat, so that there will be a volume 8 on the oil side between the piston 5 and end bottom 3.

Clean hydraulic oil is forced into the accumulator 7 via the flushing ports 1A and 1B, bringing the oil in the volume 8 below the piston 5 into circulation at great velocity, and dirty oil is returned out via the main gate 2. When a desired cleanness grade has been achieved, the return passage 9 is closed, so that the piston 5 compresses the gas 4 and the piston 5 reaches its upper position. This cleans the cylinder wall 10 internally.

On pressure build-up, the return passage 9 is opened and the piston 5 is allowed to return to its end position on the oil side while the supply of clean hydraulic oil is maintained, and the operation is repeated until the desired cleanness grade has been achieved.

1. A method of using new flushing ports when cleaning a piston accumulator, in which clean hydraulic oil is forced into the piston accumulator via the axial bores of the flushing ports and further on in sloping bores, bringing the hydraulic oil into the volume in an upward, tangential direction below the piston, into a flushing circulation, and dirty hydraulic oil being returned out via a main port and a return passage until a cleanness grade has been reached, whereby reducing the gas pressure on the gas side of a piston in relation to the flushing pressure input from the valve, a volume is created on the oil side between the piston and the end bottom; that the return passage is closed and the piston is brought into its upper position, so that an internal cylinder wall is cleaned, and that upon pressure build-up, the return passage is opened and the piston returns to its end position on the oil side while the supply of clean hydraulic oil is maintained, and the operation is repeated until a grade of cleanness has been achieved.
